(19) United States
(12) Patent Application Publication
(10) Pub. No.: US 2007/0269306 A1
(43) Pub. Date: Nov. 22, 2007

(54) Fluid rotor with energy enhancements power generator

(76) Inventor: Donald E. Burg, Miami, FL (US)

Correspondence Address: Donald E. Burg, 15840 S.W. 84th Avenue, Miami, FL, 33157, US

(21) Appl. No.: 11/443,978

(22) Filed: May 30, 2006

Related U.S. Application Data
(63) Continuation-in-part of application No. 11/435,599, filed on May 17, 2006.

(51) Int. Cl. F03B 15/06

(52) U.S. Cl. 415/4.5

(57) ABSTRACT

Presented is a physically and environmentally attractive fluid energy powered rotor driven power generation system that very efficiently extracts energy from both wind and water currents and that offers easy low cost manufacture, transportation, and installation due to its modular pre-fabricated design concepts. It achieves its high efficiencies by redirecting incoming fluids forward to add positive rotational energy to a side of the rotor what would otherwise have an anti-rotational drag force component.

### CROSS REFERENCE TO OTHER APPLICATIONS

This application is a continuation-in-part to U.S. application Ser. No. 11/435,599 filed May 17, 2006.

### BACKGROUND OF THE INVENTION

Means to extract energy from nature's wind and water currents have been many over the years as is evidenced from the prior art. The largest commercial units to current state-of-the-art technology are wind turbines with a horizontal axis and several very long and slender airfoil shaped blades. The overall height of some of these units exceeds 400 feet with the blades themselves over 120 feet long. While these blades are rather efficient since they convert wind energy to rotational energy during their entire cycle of rotation there are severe shortcomings. The gearbox and electrical generator are housed in a nacelle behind the blades with the nacelle as big as a school bus and weighting many tons. All of this is supported by a very heavy vertical structure. Control mechanisms must be incorporated so that the blades can be disengaged in very high winds. This makes for a large ungainly contraption that is expensive to build, install and maintain, environmentally noisy, hazardous to passing wildlife, and generally not nice to be around.

Attempts have been made at vertical axis wind turbines which have the advantage of locating the turbine and gears on the ground with the rotor above. These are generally more compact, less expensive, less noisy, and much less hazardous to passing wildlife. However they are inherently less efficient due to their rotor blade configurations. The wind energy is captured on the downwind rotational side or working side of the turbine blades in this most common approach. However, there is a force working against rotation that occurs when the blades rotate upwind during half of the rotor's rotation. The most efficient concepts use variations of airfoil shaped blades that rotate at speeds above oncoming wind velocities. FIG. 1 of this application shows a generic version of a prior art vertical axis wind turbine rotor with three airfoil shaped blades. Note how the force of the oncoming fluid is working against rotation when the blades are going upwind.

Examples of prior art vertical axis wind turbines with turbine blades similar in configuration to applicant's FIG. 1 include: Dereng, U.S. Pat. No. 4,264,279 and Kato, et al, U.S. Pat. No. 4,285,636.

Applicant's instant invention addresses the shortcomings of both vertical and horizontal axis wind and water turbines in a highly efficient yet low cost and low maintenance design. This is accomplished by reversing direction of the passing fluid on what would normally be the upwind rotational side of the rotor so that such reverse directed fluid acts to generate positive rotational forces. In summary, the instant invention offers a low cost fluid energy converting power generation device that is more efficient than prior art vertical axis wind or water turbines. It does this while offering most all of the advantages that a vertical axis rotor turbine generator has over state-of-the-art horizontal axis airfoil blade turbine generators.

One advantage of the prior art exposed rotor vertical axis wind turbines is that they are omni-directional as far as oncoming wind is concerned. While this has it advantages it also has shortcomings. The exposed rotors of the prior art vertical axis wind turbines are subject to damage from flying objects, are inherently weak from a structural standpoint, and are environmentally unfriendly to birds and other wildlife. Applicant's instant invention, in most instances, must be rotated to face oncoming fluids, as do present day horizontal axis propeller blade type wind turbines, but has protection for its rotors, is structurally very sound, and is environmentally friendly to wildlife and neighbors. Its environmental friendliness can be further enhanced by addition of grilles over fluid inlet and discharges.

A further feature of the instant invention is that it has been purposely conceived to be built in easily transportable pre-fabricated low cost modules. The pre-fabricated modules are very simple to assemble together as a complete wind or water current powered turbine generator. The advantages of the present invention will be understood upon review of the following sections.

### SUMMARY OF THE INVENTION

A primary object of the invention is to provide a fluid energy powered rotor driven power generation system that is highly efficient, physically and environmentally attractive, and low in cost.

A further object of the invention is that the fluid energy powered rotor have fluid energized rotor blades are at least partially airfoil shaped and where the fluid energized rotor blades absorb energy from passing fluids that is then transmitted to a power generator for conversion to useful power.

It is a related object of the invention that the fluid energized rotor blades absorb energy from rearward flowing incoming fluid during a first portion of rotation of the fluid energy powered rotor and absorb energy from incoming fluid that has been at least partially redirected to be forward flowing over a second portion of rotation of said fluid energy powered rotor.

A directly related object of the invention is that redirection of the fluid flow to a forward direction be at least partially accomplished by fluid flow turning vanes.

Yet another object of the invention is that fluid flow directing means separate incoming fluid flow to opposite sides of the fluid energy powered rotor.

Another object of the invention is that it comprise frontal area increasing outward boundary means that increase the amount of incoming flow directed to the rotor blades.

Still another object of the invention is that it further comprise means to rotate an inlet to the fluid energy powered rotor to a direction in alignment with oncoming fluids.

A directly related object of the invention is that means to rotate an inlet to the fluid energy powered rotor include a powered actuator.

Yet another object of the invention is that a disconnect mechanism be positioned between the power generator and the fluid energy powered rotor.

An important cost saving object of the invention is that it be composed of pre-fabricated modules.

A directly related object of the invention is that the pre-fabricated modules include a base module and one or more rotor modules.

A further related object of the invention is that onto the stationary base module is mounted a rotatable base module onto which is mounted a fluid energy powered rotor module.

A related object of the invention is that energy to rotate the base module be supplied by a powered actuator.

Yet another object of the invention is that the fluid energized rotor blades have, at least in part, an airfoil shape.

### BRIEF DESCRIPTION OF THE DRAWINGS

FIG. 1 is a cross-section of a prior art fluid rotor that is being rotationally driven by approaching fluids. This is the arrangement of some vertical axis windmills or wind turbines. Note that the driving fluid is pushing on the rotor blades on the downwind or working part of rotation and acting against rotation on the upwind part of rotation.

FIG. 2 presents a cross-section, as taken through plane 2-2 of FIG. 6, of a preferred embodiment fluid rotor and related structure to the instant invention. Note that: 1) More incoming fluid is directed toward the rotor due to the enlarged capture area forward of the rotor and 2) Incoming fluid that would normally work against rotation on the upwind side of rotation has been redirected so that it adds positively to rotational force rather than creating a parasitic rotational drag force as is the case for the prior art rotor presented in FIG. 1.

FIG. 3 presents a cross section of a mounting base assembly including a power generator. Coupled to that is an adapter assembly including gearing to a preferred embodiment of the invention.

FIG. 4 is a cross section, as taken through plane 4-4 of FIG. 3, that shows workings of gears that drive the power generator. Note that, while an electric generator is most common, any type of power generator including hydraulic or other may be used to absorb the rotational power from the turbine rotor(s).

FIG. 5 shows an end view of a rotor assembly module to a preferred embodiment of the instant invention.

FIG. 6 gives a side view of the rotor assembly module of FIG. 5.

FIG. 7 is an end view of a cover to a preferred embodiment of the instant invention.

FIG. 8 presents a side view of the cover of FIG. 6.

FIG. 9 gives an end view, in this case a top view, of an assembled and functional Fluid Rotor with Energy Enhancement (FREE) Power Generator to a preferred embodiment of the invention.

FIG. 10 is a side view of an assembled and functional unit to the invention. In this instance, two rotor modules have been employed. Note that any number of rotor modules may be used.

FIG. 11 presents a front view of the assembled unit. Note the simple construction of this pre-fabricated unit. The base (A), normally including the power generator, is first set in concrete or a similar material; the geared adapter housing assembly (B) is installed next, followed by one, two, or more rotor module assemblies (C), and then an end cap (D). This pre-fabrication approach of the instant invention allows for very low cost fabrication, shipping, and assembly.

FIG. 12 shows an end, or in this case top, view of a rotor.

FIG. 13 gives a side view of the rotor of FIG. 12.

FIG. 14 presents a cross-sectional view, as taken through plane 14-14 of FIG. 13, that shows a preferred airfoil shape of three rotor blades. Note that, while three blade designs appear optimal, that more or less blades may be used. Also, the shape of the blades may be modified and the angle of attack of the blades may be different than shown.

### DETAILED DESCRIPTION

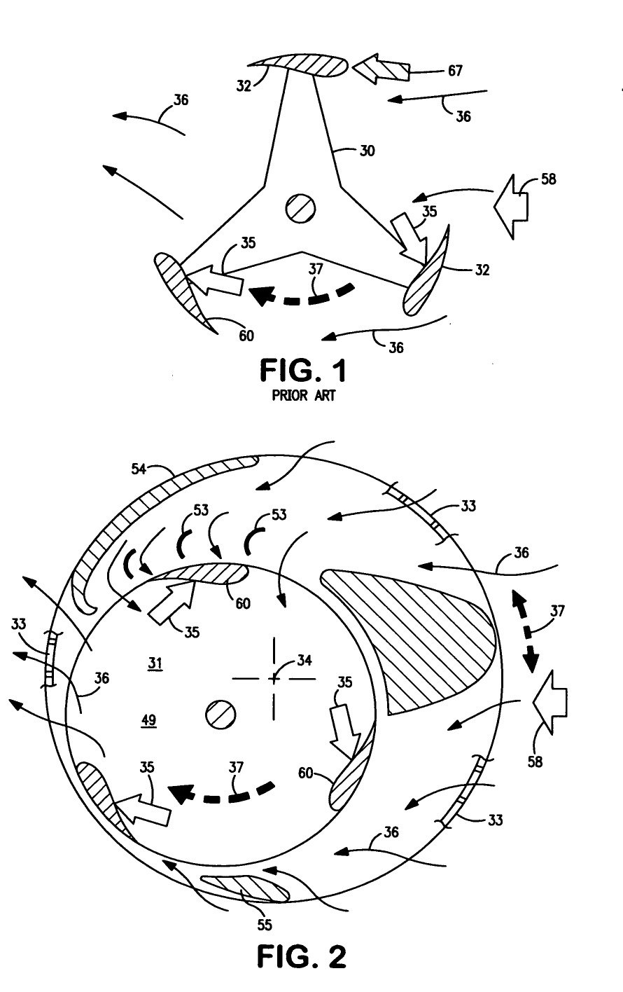

FIG. 1 is a cross-section of a prior art fluid rotor 30 that is being rotationally driven, as indicated by rotation arrow 37, by approaching fluids that are indicated by fluid flow arrows 36. This is the arrangement of some vertical axis windmills or wind turbines. Note that the driving fluid is working to generate a positive rotational torque on the rotor blades 60 on the downwind part of rotation as shown by force arrows 35. These oncoming fluid forces are acting against rotation, as indicated by anti-rotation or rotational parasitic drag force arrows 67, on the upwind part of rotor rotation where they act against rotation. While this exposed rotor blade prior art is low in cost and omni-directional as far as oncoming wind in concerned it is inherently weak from a structural standpoint, has rotor blades that are subject to impact damage from objects, is unsightly and ungainly, and is environmentally unfriendly to wildlife and neighbors.

FIG. 2 presents a cross-section, as taken through plane 2-2 of FIG. 6, of a preferred embodiment fluid rotor 31 and related structural to the instant invention. Note that: 1) More incoming fluid is directed toward the rotor 31 due to the enlarged capture area forward of the rotor 31 and 2) Incoming fluid that would normally work against rotation on the upwind side of rotation has been redirected so that it adds positively to rotational force rather than creating a parasitic rotational drag force as is the case for the prior art rotor 30 presented in FIG. 1. This can be seen by looking at the force vector arrows 35 that are all providing positive rotational energy here. This compares to the prior art rotor 30 presented in FIG. 1 where the rotational parasitic drag force arrows 67 are working against rotation on the upwind side of rotation. The rotational centerline 34 of the complete assembly is also shown. Protective fluid flow grille(s) 33 may also be incorporated.

Looking at FIG. 2 in more detail, we have, as an optimum shape, an airfoil shaped nose cone structure 38 that smoothly directs and accelerates incoming fluids, positive rotation side capture plate(s) 55, 61, negative rotation side capture plate 54, and fluid turning or redirecting vane(s) 53. By use this or another arrangement whereby the negative rotation side incoming fluid flow is redirected forward, we are able to have positive rotational energy impacting the rotor blades during their rotation. This contrasts to the prior art presented in FIG. 1 whereby there is a negative or parasitic drag during the rotor blades upwind rotation. The optional flow passageway 62 provides an inlet to direct more positive direction incoming fluid flow 36 to the rotor blades 31.

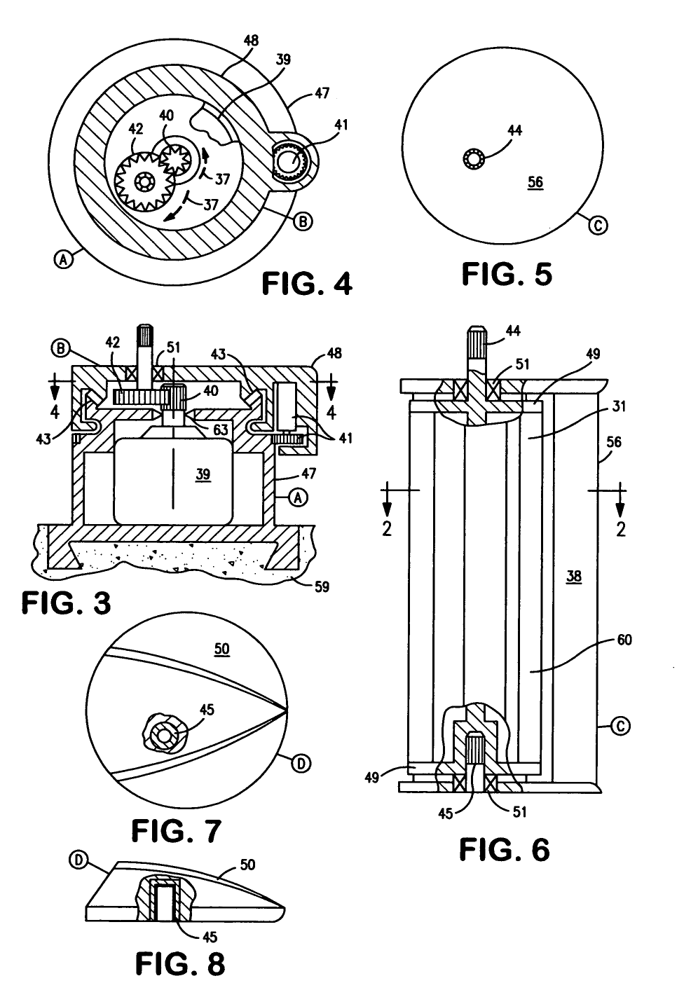

FIG. 3 presents a cross section of a mounting base assembly (A) 47 including a power generator 39. On top of that is an adapter assembly or module (B) 48 that normally includes gearing 42 that drives the generator gear 40. The procedure for assembly at a site is to first position and set the mounting base assembly (A) 47 in concrete or other material. The generator 39 and bearings 43 are then set into place. At that point the adapter module 43 is aligned and put in place. Other items shown are shaft bearing 51, seals 63, and rotational drive motor and gear 41.

FIG. 4 is a cross section, as taken through plane 44 of FIG. 3, that shows workings of gears 42 that drive the power generator gear 40. Note that, while an electric generator is most common, any type of power generator 39 including hydraulic or other may be used to absorb the fluid power from the turbine rotor(s). Further, it may be desirable to incorporate a disconnect clutch, not shown, so that the power generator 39 may be disengaged for maintenance or during very high fluid velocity situations, such as may occur in windstorms. It is important to note that the instant invention may be utilized with any fluid media. This means that, in additional to use as a wind turbine, it may be used as a water turbine in rivers, the Gulf Stream, or the like.

FIG. 5 shows an end view of a rotor assembly module (C) 56 including a splined drive shaft 44 to a preferred embodiment of the instant invention.

FIG. 6 gives a side view of the rotor assembly module (C) 56 presented in FIG. 5. Cutaway views show shaft support bearings 51, female spline/bearing adapter 45, and male spline adapter 44. A further cutaway view shows portions of a rotor 31 including rotor end plates 49.

FIG. 7 is an end view of a cover (D) 50 including a female bearing adapter 45 to a preferred embodiment of the instant invention.

FIG. 8 presents a side view of the cover (D) 50 of FIG. 6.

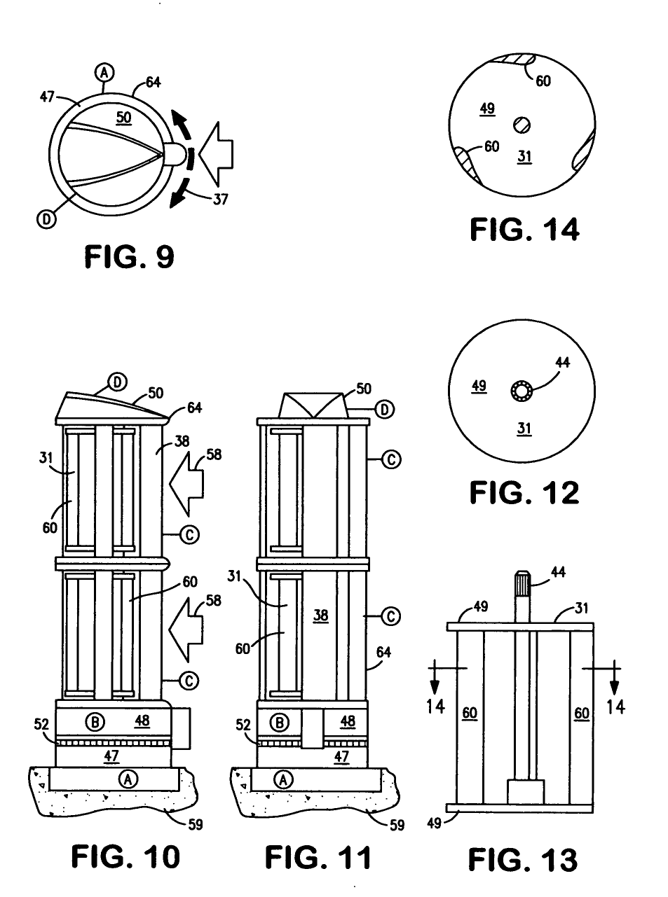

FIG. 9 gives an end view, in this case a top view, of an assembled and functional Fluid Rotor with Energy Enhancement (FREE) Power Generation System 64 to a preferred embodiment of the invention. Note that the FREE Power Generation System 64 may be oriented in any direction.

FIG. 10 gives a side view of an assembled and functional FREE Power Generation System 64 to the instant invention. In this instance, two rotor modules (C) 56 have been employed. Note that any number of rotor modules (C) 56 may be employed. A gear track 52 used during rotation of the FREE Power Generation System 64 is also shown here. Direction of fluid flow is indicated by fluid flow arrows 36. The fluid flow grilles shown in FIG. 2 are optional and not shown here.

FIG. 11 presents a front view of an assembled FREE Generator 64. Note the simple construction of this pre-fabricated unit. The base (A) 46, normally including the power generator, is first set in concrete or a similar material; the geared adapter housing assembly (B) 48 is installed next, followed by one, two, or more rotor module assemblies (C) 56, and then an end cap (D) 50. This pre-fabrication approach of the instant invention allows for very low cost fabrication, shipping, and assembly. Further, it is physically and environmentally acceptable and attractive.

FIG. 12 presents a top or end view of a rotor 31 and its preferred simple end cap 49 design.

FIG. 13 is a profile view of a rotor 31 showing end caps 49 and rotor blades 60.

FIG. 14 is a cross-sectional view, as taken through plane 14-14 of FIG. 13, showing the rotor 49, rotor blades 60, and rotor end plate 49.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In a fluid energy powered rotor driven power generation system with said fluid energy powered rotor having fluid energized rotor blades wherein said fluid energized rotor blades absorb energy from passing fluids with said energy transmitted to a power generator for conversion to useful power, the improvement comprising:
said fluid energized rotor blades absorb energy from rearward flowing incoming fluid during a first portion of rotation of said fluid energy powered rotor and absorb energy from incoming fluid that has been at least partially redirected by fluid flow turning means to be forward flowing over a second portion of rotation of said fluid energy powered rotor thereby providing positive rotational energy over a majority of the rotation of the fluid energy powered rotor.

2. The fluid energy powered rotor driven power generation system of claim 1 wherein said fluid flow turning means includes fluid flow turning vanes.

3. The fluid energy powered rotor driven power generation system of claim 1 which further comprises flow separation means wherein said flow separation means separates incoming fluid flow to opposite sides of the fluid energy powered rotor.

4. The fluid energy powered rotor driven power generation system of claim 1 which further comprises frontal area increasing outward boundary means that increase the amount of incoming flow directed to the fluid energized rotor blades.

5. The fluid energy powered rotor driven power generating system of claim 4 wherein said frontal area increasing outward boundary means includes stationary curvilinear elements.

6. The fluid energy powered rotor driven power generation system of claim 1 which further comprises means to rotate an inlet to the fluid energy powered rotor to a direction in alignment with oncoming fluids.

7. The fluid energy powered rotor driven power generation system of claim 6 wherein said means to rotate an inlet to the fluid powered rotor includes a powered actuator.

8. The fluid energy powered rotor driven power generation system of claim 1 wherein a disconnect mechanism is positioned between the power generator and the fluid energy powered rotor.

9. The fluid energy powered rotor driven power generation system of claim 1 wherein said fluid energy powered rotor driven power generation system includes pre-fabricated modules.

10. The fluid energy powered rotor driven power generation system of claim 9 wherein said pre-fabricated modules include a base module and one or more rotor modules.

11. The fluid energy powered rotor driven power generation system of claim 1 wherein said fluid energized rotor blades have, at least in part, an airfoil shape.

12. The fluid energy powered rotor driven power generation system of claim 1 which further comprises one or more fluid flow grilles.

13. In a fluid energy powered rotor driven power generation system with said fluid energy powered rotor having fluid energized rotor blades wherein said fluid energized rotor blades absorb energy from passing fluids with said energy transmitted to a power generator for conversion to useful power, the improvement comprising:
a base module upon which is mounted a rotatable fluid energy powered rotor module and wherein energy to rotate the rotatable fluid energy powered rotor module is supplied by a powered actuator and wherein said rotatable fluid energy powered rotor module is rotated such that a fluid inlet of the fluid powered rotor module is in alignment with oncoming fluids and which further comprises fluid flow turning means disposed to redirect rearward flowing incoming fluid to forward flowing fluid prior to said fluid contacting the fluid energized rotor blades.

14. The fluid energy powered rotor driven generator system of claim 13 wherein said fluid energized rotor blades absorb energy from rearward flowing incoming fluid during a first portion of rotation of said fluid energy powered rotor and absorb energy from the incoming fluid that has been at least partially redirected to be forward flowing over a second portion of rotation of said fluid energy powered rotor.

15. The fluid energy powered rotor driven power generation system of claim 14 wherein said fluid flow turning means includes fluid flow turning vanes.

16. The fluid energy powered rotor driven power generation system of claim 16 which further comprises one or more fluid flow grilles.

17. In a fluid energy powered rotor driven power generation system with said fluid energy powered rotor having fluid energized rotor blades wherein said fluid energized rotor blades absorb energy from passing fluids with said energy transmitted to a power generator for conversion to useful power, the improvement comprising:
fluid directing means consisting of one or more fluid directing elements direct fluids to said fluid energized rotor blades rotating away from said fluid directing means and direct fluids to the fluid energized rotor blades rotor blades that are rotating toward said fluid directing means and wherein fluids directed toward said approaching fluid energized rotor blades by said fluid directing means are redirected so that they are moving in a direction of rotation of said fluid energized rotor blades.

18. The fluid energy powered rotor driven power generation system of claim 17 wherein redirection of said fluids is accomplished, at least in part, by fluid flow turning vanes.

19. The fluid energy powered rotor driven power generation system of claim 17 which further comprises one or more fluid flow grilles.

20. The fluid energy powered rotor driven power generation system of claim 17 wherein said fluid energized rotor blades have, at least in part, an airfoil shape.
